(19) United States
(12) Patent Application Publication
(10) Pub. No.: US 2006/0288166 A1
(43) Pub. Date: Dec. 21, 2006

(54) System, method, and computer program product for nonvolatile memory devices

(75) Inventors: William R. Smith JR., Dallas, TX (US); Daniel F. Kieley, Dallas, TX (US)

Correspondence Address: DOCKET CLERK, P.O. DRAWER 800889, DALLAS, TX, 75380, US

(73) Assignee: Wanderback LLC, Dallas, TX (US)

(21) Appl. No.: 11/285,703

(22) Filed: Nov. 21, 2005

Related U.S. Application Data
(60) Provisional application No. 60/691,825, filed on Jun. 17, 2005.

(51) Int. Cl. G06F 12/00

(52) U.S. Cl. 711/115; 711/103

(57) ABSTRACT

A system, method, and computer program product for nonvolatile memory devices. One implementation includes a method for managing data in a nonvolatile memory device, comprising attaching a removable nonvolatile memory device to a host system; activating the nonvolatile memory device by the host system; in response to activating, contacting a server system over a network at an address stored on the nonvolatile memory device; receiving data from the server system; and storing the data on the nonvolatile memory device.

### CROSS-REFERENCE TO OTHER APPLICATION

This application claims priority from U.S. Provisional Patent Application 60/691,825, filed Jun. 17, 2005, which is hereby incorporated by reference.

### TECHNICAL FIELD OF THE INVENTION

The present invention is directed, in general, to systems and methods for operating nonvolatile memory devices.

### BACKGROUND OF THE INVENTION

Nonvolatile memory devices have become common means for easily storing and transporting data, for expanding the available memory of electronic devices, and for providing compact, reliable storage of computer software and related data and other content. Nonvolatile memory is a general term for all forms of solid state memory that do not require the memory contents to be periodically refreshed. As known to those of skill in the art, this includes all forms of read-only memory (ROM) such as programmable read-only memory (PROM), erasable programmable read-only memory (EPROM), electrically erasable programmable read-only memory (EEPROM), and flash memory. Flash memory (sometimes called “flash RAM”) is a type of constantly-powered nonvolatile memory that can be erased and reprogrammed in units of memory called blocks. It is a variation of electrically erasable programmable read-only memory (EEPROM)and is often used to hold control code such as the basic input/output system (BIOS) in a personal computer. When BIOS needs to be changed (rewritten), the flash memory can be written to in block (rather than byte) sizes, making it easy to update. On the other hand, flash memory is not useful as random access memory (RAM) because RAM needs to be addressable at the byte (not the block) level.

“Flash drives” are compact, portable memory storage devices that perform a function similar to a computer hard drive. Typically (but not necessarily) constructed of flash memory, they are small enough to be carried in one's pocket, on a key chain, or on a fabric ribbon around one's neck, and can hold as much as two gigabytes of data or more.

A typical flash drive is one compatible with universal serial bus (USB) architecture. A typical USB flash drive will plug into the USB port of a data processing system or other electronic device and can easily carry data from one computer, PDA, etc. to another with a much larger capacity than a floppy disk, CD or the like.

When plugged into a data processing system, a USB flash drive will typically be recognized by the operating system as a standard hard disk drive, and software and data on the USB flash drive can be accessed by the data processing system as can any data on a hard drive.

There is, therefore, a need in the art for improved systems, methods, and computer program products for nonvolatile memory devices including flash drives.

### SUMMARY OF THE INVENTION

According to one disclosed embodiment, there is provided a method for managing data in a nonvolatile memory device, comprising attaching a removable nonvolatile memory device to a host system; activating the nonvolatile memory device by the host system; in response to activating, contacting a server system over a network at an address stored on the nonvolatile memory device; receiving data from the server system; and storing the data on the nonvolatile memory device.

According to another disclosed embodiment, there is provided a removable nonvolatile memory device, comprising a user memory area accessible to a user of a host system when the nonvolatile memory device is attached to and activated by the host system; and a reserved memory area storing encoded data not directly accessible to the user, the encoded data including a computer program product configured to, in response to attached to and activated by the host system, contact a server system over a network at an address stored on the nonvolatile memory device, receive downloaded data from the server system, and store the downloaded data on the nonvolatile memory device.

According to another disclosed embodiment, there is provided a computer program product tangibly embodied in a machine-readable medium, comprising instructions for contacting a server system over a network at an address stored on a removable nonvolatile memory device, in response to detecting that a removable nonvolatile memory device has been attached to and activated by a host system; instructions for receiving downloaded data from the server system; and instructions for storing the downloaded data on the nonvolatile memory device.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which a preferred embodiment can be implemented;

FIG. 2 depicts a simplified block diagram of a nonvolatile memory device in accordance with a disclosed embodiment of the present invention; and

FIG. 3 depicts a flowchart of a process in accordance with preferred embodiments.

### DETAILED DESCRIPTION OF THE INVENTION

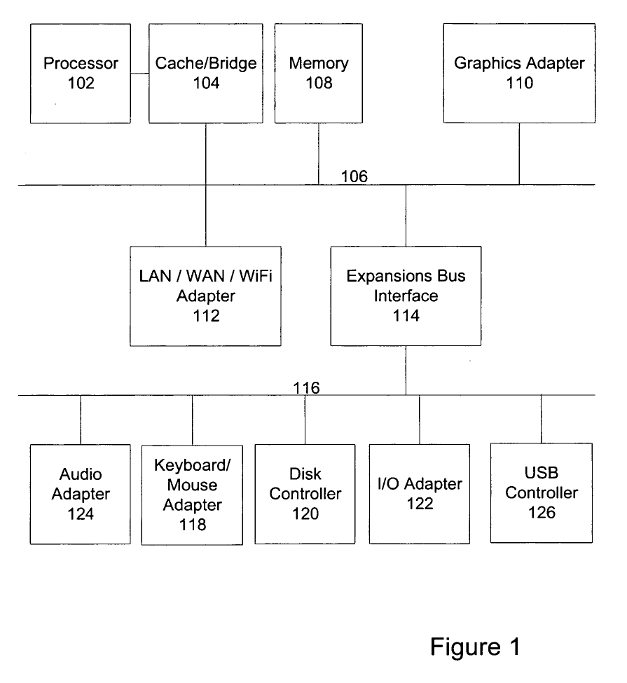

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

Below, an exemplary data processing system context is disclosed with which a nonvolatile memory in accordance with the preferred embodiment can be used. Following that is a more detailed description of various implementations of systems, methods, and computer program products for nonvolatile memory devices including flash drives, in accordance with various embodiments of the present inventions.

FIG. 1 depicts a block diagram of a data processing system in which a preferred embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Also connected to the I/O bus 116 in the example shown is universal serial bus (USB) controller 126, which will also include one or more USB connectors and/or USB hubs, known to those of skill in the art, for connecting one or more USB-compatible devices, including USB flash drives.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

USB flash drives are currently widely available for data storage and transportation in a universally accessible format. “Flash sticks,” as used herein, refers to nonvolatile memory devices, preferably USB flash drives, with a protected area containing specific data which will be constantly updateable via access to a network, such as the internet and the World Wide Web. The flash sticks also preferably include a separate, user-accessible area that a user can utilize for data storage, other applications, etc.

The flash sticks include an auto-play feature which will automatically launch appropriate programs for the viewing of the included data, as well as those needed to accomplish the ancillary tasks of regularly updating the data via an Internet connection as well as adding and subtracting various segments of the included media. In a preferred embodiment, and as described in more detail below, upon attachment to a computer system, the flash stick will automatically execute a process to search for a network connection to a specified network address, typically an internet address, check for an update to its installed software or content, and download any appropriate update.

Note that, as used herein, terms such as “attached to”, “attachment”, “coupled to”, “plugged in”, and similar terms indicate a direct or indirect communication between the subject devices, as they are normally used, and are not limited to a single direct attachment. For example, when a USB flash stick is referred to as “plugged into” a data processing system, that means that it can be directly plugged into a USB port on that system, or can be configured to communicate with that system via USB cords, a USB hub, or other adapters or connectors known to those of skill in the art.

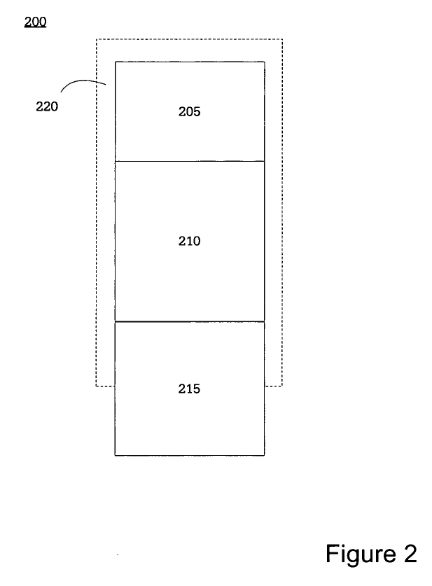

FIG. 2 depicts a simplified block diagram of a nonvolatile memory device 200 in accordance with a disclosed embodiment of the present invention. Here, the nonvolatile memory device 200 includes a reserved memory area 205, a user memory area 210, and a connector 215. Reserved memory area 205 and user memory area 210 together comprise the total partitioned memory of the nonvolatile memory device 200. Connector 215 allows the nonvolatile memory device 200 to communicate with other suitable devices, as in a typical USB connector. Housing 220 protects reserved memory area 205, user memory area 210, and the connection between the memory and connector 215.

It should be noted that this figure is illustrative, not to scale, and not limiting. This figure generally corresponds to well-known flash drives, with the exception that the typical flash drive does not partition the memory as described. Further, the user memory area and the reserved memory area are, in some embodiments, separate formal partitions in the sense that each is dedicated to a particular function and accessed as a single unit, or are stored in separately-accessed memories. In other embodiments, there is a single physical memory comprising both the reserved memory area and the user memory area, and the assignment of portions of the memory to each can be done, for example, at the time the initial software is loaded. For example, a fixed-size or variable-sized portion of the memory could be assigned to a single-file virtual disk to act as the reserved memory area or the user memory area. Other separation or partitioning between the user memory area and the reserved memory area can be performed by any means known to those of skill in the art.

In general, according to a preferred embodiment, reserved memory area 205 is used for system software and content that is not directly accessible or modifiable by the user, as described in more detail below. The user memory area 210, in a preferred embodiment, is accessible and usable by a user as a typical flash drive.

In various embodiments, reserved memory area 205 is also encoded or encrypted, in whole or in part, so that some or all of the programs and content stored in that area of the memory cannot be readily read by the user or the hosting data processing system or device.

In some implementations, the flash sticks can be implemented using a nonvolatile memory device according the the U3 “smart drive” (specifications and information available as of time of filing at www.u3.com). Other implementations that allow a data area for the user and a protected area for the system data can be implemented using USB drives that contain an M-Systems (www.m-systems.com) control chip, a Hagiwara Sys-Com (www.hsc-us.com) chip or other vendors' solutions. These commercially-available chips make a USB nonvolatile memory device appear as two devices to a host data processing system, and readable as two separate drive letters. The first drive will identify itself as a USB CDROM drive and the second will be USB hard drive. The CDROM partition will be identified by the target operating system as a device that supports autorun and the USB CDROM drive will be searched and if the drive has an autorun file it will be executed.

Using the CDROM partition of such a drive as reserved memory area 205 is effective for implementing the functions described below. In various embodiments, this type of USB device would autorun a program as described below without the need to load any code on the user's computer and would provide for a user area that can optionally be protected by a password. In such an implementation, the hardware enforces the partitioning at a level below the user computer's operating system.

An important part of the operation of various embodiments is an auto-update function for updating programs and/or content via a network connection such as the internet or a corporate internet connection. For example, this automatic update could retrieve updated sports statistics over the internet for a fantasy sports league, could retrieve updated stock and securities figures over the internet for a portfolio management application, or could retrieve updated sales figures, inventory numbers, and pricing from an internal company server for a sales management application. In other implementations, the system could automatically download multimedia content such as exclusive video or music content.

In other embodiments, in addition to the auto-update function, the flash stick is configured so that the host data processing system can actually boot from the flash stick, executing only programs on the flash stick, and leaving nothing on the host system itself when the flash stick is removed. In this manner, the flash stick can effectively produce a customized data processing system for a user wherever the user plugs in the flash stick.

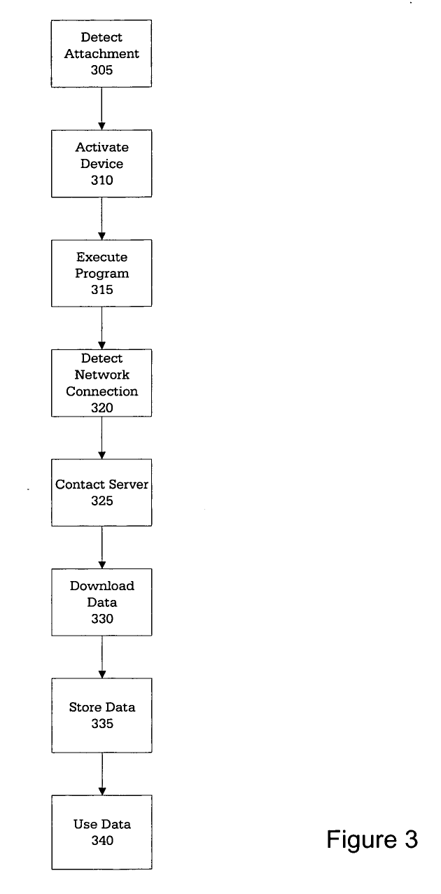

FIG. 3 depicts a flowchart of a process in accordance with preferred embodiments, which can also be implemented as machine-readable instructions tangibly embodied in a machine-readable medium, or as a nonvolatile memory device particularly configured to perform the process.

The first part of this process is detecting the attachment of the nonvolatile memory device to a data processing system or other compatible host device (step 305), referred to hereafter as simply the “host system”.

The host system system will then activate the device (step 310), in a manner conventional to such devices, e.g., as activating a USB flash drive.

The host system will then execute a program stored in the reserved memory area of the nonvolatile memory device (step 315). Preferably, the program is “auto-run” or executed automatically upon activation of the non-volatile memory device, but in alternate embodiments the program is manually activated by a user “selecting” the non-volatile memory device on the host system, or uses a software interface to activate the program.

The program will then detect whether the host system has an available network connection (step 320). Note that the program can otherwise be of any known type, as required by the specific user or manufacturer needs, and may perform other tasks before, after, or while it is performing the tasks described herein.

Upon detection of an available network connection, the program will attempt to contact a server system over the network connection (step 325), as described herein. The server can be on a local network, over the internet, or otherwise. The address of the server, whether by Uniform Resource Locator (URL), internet protocol (IP) address, or otherwise, is stored on the nonvolatile memory device.

Upon connection with the server system, and any appropriate authentication/validation unimportant to understanding the processes herein, the program will download data from the server system (step 330). The data can be updated programs or other content or data.

The downloaded data is stored on the nonvolatile memory device (step 335). Preferably, the downloaded data is stored in the reserved memory area, and is encrypted or otherwise encoded, using methods known to those of skill in the art.

The program will then perform a user interaction, of any appropriate type according to the user or manufacturer requirement, using the downloaded data (step 340).

Note that while “the program” is referred to herein, this term is not intended to limit the actual structure or execution of the steps described. Indeed, the program can be a single program, multiple programs, one or more scripts, plug-ins or extensions to other programs, or otherwise, as will be recognized by those of skill in the art.

A significant feature of preferred embodiments is that steps 320-335 are performed automatically, as soon as the nonvolatile memory device is activated, if the program can auto-run, or as soon as the program is run, if it must be started manually. In this way, whenever the flash stick is activated and can access the server, it is preferably immediately and automatically updated as necessary.

Of course, in some cases, no update will be necessary or appropriate, which the program will determine after connecting with the server.

In preferred embodiments, each flash stick includes a unique identifier, such as a serial number, that identifies it to the server system. This identifier can be used both to determine what data should be downloaded, and for authentication/accounting/tracking purposes on the server.

In some embodiments, the program will use the normal Web HTTP port of 80 for a possible non-HTTP based protocol. This approach would aid the device in communicating past firewall filters.

As may be readily seen by the skilled artisan, an automatically-updating nonvolatile memory device such as the disclosed flash sticks have immediate application in such areas as entertainment distribution, pharmaceutical marketing, sports fantasy leagues including all related statistics, and general consumer marketing for unique product placement. The use of the flash drive has, almost universally, been seen as portable storage receptacle for the consumer's data transportation. Various disclosed embodiments include using it as a means of distribution of new and infinitely updateable information which will automatically play when connected to any USB-equipped device. In addition, the information automatically updates via the Internet when the flash stick is connected to a device with World Wide Web access.

The consumer thereby is not buying a static product, but a dynamic one that will provide an ongoing benefit into the future. An example would be, as test results on a pharmaceutical product are received, those results can be disseminated to all flash sticks in the field with the newest information thereby keeping those in related medical fields constantly updated on any applicable information which could be critical to their use of the marketed product.

In the case of fantasy leagues, player statistics can be updated constantly to provide an ongoing usability versus a one time download of information onto a disc or drive. These updates are automatic and ongoing to insure the long term value of the flash stick.

The data transferred to the flash stick can, in some embodiments, be sales and advertising oriented and can be designed to be an entertaining and informative format. Some specialized, market-driven content can be designed for the download, and not available for general consumption except to customers that use products delivered by device. As a feedback measure the vendor could provide an “I want a copy of this” button to allow the consumer to obtain a copy of the vendor ad. If this is free or a pay service is up to the vendor, either way the device can record the user's selection of this request.

The server system described herein can be implemented as any conventional network-accessible server system, so long as it can perform as described and respond to the flash stick as described. In particular, the server will receive an access request from the host system that identifies the particular flash stick attached to that host system. The server will authenticate the request. Based on that particular flash stick, the user may be required to agree to a license agreement when connecting, or the server may require other, user-based authentication such as a password.

The server will then check the status of the flash stick, preferably using a database that tracks the status and upload/download history associated with the unique identifier of that flash stick. The server will then determine, based on the status, any software or content downloads appropriate for that flash stick, and will download the corresponding data to the host system to be stored on the flash stick.

Those skilled in the art will recognize that, for simplicity and clarity, the full structure and operation of all data processing systems or nonvolatile memory devices suitable for use with the present invention is not being depicted or described herein. Instead, only so much of such systems as is unique to the present invention or necessary for an understanding of the present invention is depicted and described. The remainder of the construction and operation of the data processing system or nonvolatile memory device may conform to any of the various current implementations and practices known in the art.

It is important to note that while the present invention has been described in the context of a fully functional system, those skilled in the art will appreciate that at least portions of the mechanism of the present invention are capable of being distributed in the form of ?instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives, and optical storage mediums such as compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for managing data in a nonvolatile memory device, comprising:
attaching a removable nonvolatile memory device to a host system;
activating the nonvolatile memory device by the host system;
in response to activating, contacting a server system over a network at an address stored on the nonvolatile memory device;
receiving data from the server system; and
storing the data on the nonvolatile memory device.

2. The method of claim 1, wherein the contacting, receiving, and storing are all performed automatically when the nonvolatile memory device is activated.

3. The method of claim 1, wherein the activation automatically performed in response to the attaching.

4. The method of claim 1, wherein the contacting, receiving, and storing are all performed according to a computer program stored on the nonvolatile memory device.

5. The method of claim 1, wherein the address and the data are stored in a reserved memory area of the nonvolatile memory device that is inaccessible to a user.

6. The method of claim 1, wherein the nonvolatile memory device includes a unique identifier that is used by the server system to determine the data to be received and stored on the nonvolatile memory device.

7. The method of claim 1, wherein the data includes at least one of multimedia content, financial data, and a software program update.

8. A removable nonvolatile memory device, comprising:
a user memory area accessible to a user of a host system when the nonvolatile memory device is attached to and activated by the host system; and
a reserved memory area storing encoded data not directly accessible to the user,
the encoded data including a computer program product configured to, in response to attached to and activated by the host system, contact a server system over a network at an address stored on the nonvolatile memory device,
receive downloaded data from the server system, and
store the downloaded data on the nonvolatile memory device.

9. The removable nonvolatile memory device of claim 8, wherein the contacting, receiving, and storing are all performed automatically when the nonvolatile memory device is activated.

10. The removable nonvolatile memory device of claim 8, wherein the activation is automatically performed in response to the attaching.

11. The removable nonvolatile memory device of claim 8, wherein at least some of the downloaded data is stored in the user memory area.

12. The removable nonvolatile memory device of claim 8, wherein the address and the downloaded data are stored in the reserved memory area.

13. The removable nonvolatile memory device of claim 8, wherein the encoded data further includes a unique identifier that is used by the server system to determine the data to be received and stored on the nonvolatile memory device.

14. The removable nonvolatile memory device of claim 8, wherein the downloaded data includes at least one of multimedia content, financial data, and a software program update.

15. A computer program product tangibly embodied in a machine-readable medium, comprising:
instructions for contacting a server system over a network at an address stored on a removable nonvolatile memory device, in response to detecting that a removable nonvolatile memory device has been attached to and activated by a host system;
instructions for receiving downloaded data from the server system; and
instructions for storing the downloaded data on the nonvolatile memory device.

16. The computer program product of claim 15, wherein the instructions for contacting, receiving, and storing are all executed automatically when the nonvolatile memory device is activated.

17. The computer program product of claim 15, wherein at least some of the downloaded data is stored in a user memory area of the nonvolatile memory device.

18. The computer program product of claim 15, wherein the address and the downloaded data are stored in a reserved memory area of the nonvolatile memory device.

19. The computer program product of claim 15, further comprising instructions to read a unique identifier from the nonvolatile memory device and instructions to transmit the unique identifier to the server system.

20. The computer program product of claim 15, wherein the downloaded data includes at least one of multimedia content, financial data, and a software program update.
